(19) United States
(12) Patent Application Publication
(10) Pub. No.: US 2022/0054359 A1
(43) Pub. Date: Feb. 24, 2022

(54) Continuous Production of Filled Capsules and Method Thereof

(71) Applicants: Scitech Centre, Jogeshwari West, Mumbai (IN); AGC Pam Phama Technologies Pvt. Ltd, Kandivali (W) Mumbai (IN)

(72) Inventors: Karan Singh, Mumbai (IN); Roy Cook, Jogeshwari West, Mumbai (IN); Sumit Waghmare, Jogeshwari West, Mumbai (IN); Swapnil Desai, Jogeshwari West, Mumbai (IN); Nirajkumar Singh, Jogeshwari West, Mumbai (IN)

(21) Appl. No.: 17/296,527

(22) PCT Filed: Nov. 23, 2019
(86) PCT No.: PCT/IB19/60093

§ 371 Date: May 24, 2021

(30) Foreign Application Priority Data
Nov. 24, 2018 (IN) 201821044344

(51) Int. Cl. A61J 3/07; B65B 1/32; B65B 37/18; B65B 57/14; B65B 1/46

(52) U.S. Cl. CPC A61J 3/074; B65B 1/32; B65B 2220/14; B65B 57/145; B65B 1/46; B65B 37/18

(57) ABSTRACT

Systems and methods for continuous production of filled capsules. The system includes a continuous blender for receiving and continuously blending ingredients discharged from one or more feeders to form a blended mixture. The system includes a capsule filling machine to receive empty capsules and fill the mixture in them to provide filled capsules. The system includes multiple sensors configured at predefined positions within the system to monitor the attributes associated with the ingredients, mixture, empty capsules, and filled capsules. The system includes a control unit to control the feeders, blender, capsule filling machine and other components of the system to bring the attributes within a predefined range to ensure that the filled capsules are of predefined quality.

### CROSS-REFERENCE TO RELATED APPLICATIONS

This application is the U.S. national phase of, and claims priority to, International Application No. PCT/IB2019/060093, filed Nov. 23, 2019, which designated the U.S. and which claims priority to Indian Patent Application No. 201821044344, filed Nov. 24, 2018.

### TECHNICAL FIELD

The present disclosure relates to production/manufacturing of filled capsules. More particularly, the present disclosure relates to a production/manufacturing line for continuous production/manufacturing of filled capsules.

### BACKGROUND

Background description includes information that may be useful in understanding the present invention. It is not an admission that any of the information provided herein is prior art or relevant to the presently claimed invention, or that any publication specifically or implicitly referenced is prior art.

Manufacturing of solid oral dosage forms such as capsules is carried out either by batch processing or continuous processing. Conventional batch processing involves various ingredients of a capsule brought together through a step-by-step process. A series of steps are carried out by various types of equipment before the production of a solid oral dosage form is complete. As the materials go from step to step, a current batch must finish before a subsequent batch can be processed, resulting in low production rate and low yield. The produced dosage forms are quality tested by taking samples at regular intervals and carrying out various compliance tests on them. Such testing is generally termed as offline inspection. In case a sample fails a compliance test for the quality, the entire batch needs to be discarded. Further, in the event of damage or malfunctioning of a particular equipment, the entire manufacturing process needs to be stopped for its replacement causing the productivity to stop completely. Such a scenario may also lead to an entire batch being discarded.

In contrast to batch processing, continuous processing involves filling of empty capsules with pharmaceutical or nutraceutical ingredients to provide a final product (filled capsules) with no need to stop during production. As a result, there is no need to shut down any equipment and there is no down time as the capsules are manufactured. Thus, batch processing necessitates stopping at each step throughout the production of the capsule, while continuous processing produces filled capsule without any need to stop until the capsule filling process is complete.

Hence, drug regulatory agencies are pushing pharmaceutical companies to adopt a continuous manufacturing process. Continuous manufacturing also allows quality control to be built directly into the process of capsule production. In the case of an identified quality issue, specific quantities of a capsule produced via a continuous flow can be tracked and identified. Further, in contrast to batch processing, fewer steps requiring human intervention are involved in continuous manufacturing, thereby reducing the risk of human error. Continuous manufacturing has the potential of reducing manufacturing costs which could be passed along to consumers in the form of more affordable medicines. Continuous processing could also help in preventing drug shortages of vital medicines by reducing the lead of time of a given product.

There have been certain endeavours towards continuous manufacturing. For example, U.S. Pat. No. 9,713,575 mentions a tablet production module wherein an API and an excipient are mixed, and the mixture is compressed in a tablet press to form tablets. Further, during manufacturing of the tablets, parameters of the contents of the material stream are measured with analytical sensors upstream of the tablet press. The speed of the tablet press is controlled in response to the parameters measured upstream of the tablet press. The finished tablets are discharged at an outlet of the tablet press. However, the module mentioned in U.S. Pat. No. 9,713,575 is limited to tablet production only, and the sensors are used in the module for measuring only the material stream i.e. for measuring only the API and/or excipient.

There is, therefore, a need to provide a system for continuous manufacturing/production of filled capsules including quality control where, besides the materials/ingredients, various parameters related to the capsules, filled as well as empty, are measured for ensuring the quality of the filled capsules.

### OBJECTS OF THE PRESENT DISCLOSURE

Some of the objects of the present disclosure, which at least one embodiment herein satisfies are as listed herein below.

It is an object of the present disclosure to provide a continuous pharmaceutical and/or nutraceutical processing system for production of filled capsules.

It is an object of the present disclosure to provide a continuous pharmaceutical and/or nutraceutical processing system for production of filled capsules with built-in quality control system.

It is an object of the present disclosure to provide a continuous pharmaceutical and/or nutraceutical processing system wherein various parameters related to the materials/ingredients used for manufacturing the capsules, as well as, the filled and empty capsules, are measured for ensuring the quality of the filled capsules.

It is an object of the present disclosure to eliminate the risk of human error in continuous manufacturing of filled capsules by reducing human intervention during manufacturing.

### SUMMARY

The present disclosure relates to production/manufacturing of filled capsules. More particularly, the present disclosure relates to a production/manufacturing line for continuous production/manufacturing of filled capsules.

An aspect of the present disclosure pertains to a system for continuous production of filled capsule, the system comprising: at least one continuous blender configured to receive and continuously blend a first ingredient and a second ingredient to form a mixture; and a capsule filling machine fluidically coupled with the at least one continuous blender, wherein the capsule filling machine may be adapted to fill a plurality of empty capsules with the mixture produced by the at least one continuous blender to provide a plurality of filled capsules.

In an aspect, the system may comprise at least one first feeder fluidically coupled to a first inlet of the at least one continuous blender and may be configured to supply the first ingredient to the at least one continuous blender; and at least one second feeder fluidically coupled to a second inlet of the at least one continuous blender and may be configured to supply the second ingredient to the at least one continuous blender.

In an aspect, the system may comprise one or more sensors positioned at predetermined positions in the system and may be configured to monitor one or more attributes of any or a combination of the first ingredient, the second ingredient, the mixture, the plurality of empty capsules, and the plurality of filled capsules.

In an aspect, the system may comprise a control unit operatively coupled with the one or more sensors, the at least one continuous blender, the capsule filling machine, the at least one first feeder, and the at least one second feeder, and wherein the control unit may be adapted to transmit a set of control signals to any or a combination of the at least one continuous blender, the capsule filling machine, the at least one first feeder, and the at least one second feeder to configure the one or more attributes within a predefined range.

In an aspect, the system may comprise a set of first sensors configured with the at least one first feeder to monitor one or more first ingredients attributes; and a set of second sensors configured with the at least one second feeder to monitor one or more second ingredients attributes, and wherein the one or more first ingredient attributes and the one or more second ingredient attributes may comprise any or a combination of blend uniformity, concentration, fingerprint, flowability, moisture content, weight, and particle size distribution.

In an aspect, the system may comprise a first reservoir fluidically coupled to the at least one first feeder and may be adapted to store the first ingredient, and the system may comprise a second reservoir fluidically coupled to the at least one second feeder and may be adapted to store the second ingredient.

In an aspect, the at least one first feeder and the at least one second feeder may comprise any or a combination of gravimetric feeder, and volumetric feeder to discharge a predefined quantity of the first ingredient and the second ingredient from the corresponding feeders.

In an aspect, the system may comprise a first particle sizer adapted to allow the first ingredients having a first predefined size to flow from the at least one first feeder to the at least one continuous blender, and wherein the system may comprise a second particle sizer adapted to allow the second ingredients having a second predefined size to flow from the at least one second feeder to the at least one continuous blender.

In an aspect, the system may comprise a set of third sensors configured with the first particle sizer to monitor one or more first ingredients attributes of the first ingredients discharged from the first particle sizer; and a set of fourth sensors configured with the second particle sizer to monitor one or more second ingredients attributes of the second ingredients discharged from the second particle sizer.

In an aspect, the system may comprise a first valve operatively coupled to the at least one first feeder to control outflow of the first ingredients to the at least one first feeder, and wherein the system may comprise a second valve operatively coupled to the at least one second feeder to control outflow of the second ingredients to the at least one second feeder.

In an aspect, the system may comprise a set of fifth sensors positioned at an outlet of the at least one continuous blender and may be configured to monitor one or more mixture attributes associated with the mixture discharged from the outlet, and wherein the one or more mixture attributes may comprise any or a combination of uniformity, concentration, fingerprint, flowability, moisture content, and particle size distribution.

In an aspect, the system may comprise a diverter valve configured with the at least one continuous blender and may be adapted to divert the flow of the mixture having the one or more mixture attributes within a predefined range to the capsule filling machine.

In an aspect, the diverter valve may be configured to divert the flow of the mixture failing to have the one or more mixture attributes within the predefined range to a rejection bin.

In an aspect, the system may comprise a set of sixth sensors positioned at a location of the system to monitor location parameters comprising any or a combination of temperature, humidity, wind speed, and pressure.

In an aspect, the system may comprise a capsule diagnosis unit fluidically coupled to the capsule filling machine, the capsule diagnosis unit may be configured to detect defects in the plurality of empty capsules and allow the plurality of empty capsules having a predetermined quality to pass to the capsule filling machine.

In an aspect, the system may comprise a set of seventh sensors configured with the capsule filling machine and may be adapted to monitor one or more capsule attributes of the plurality of capsules, and wherein the one or more capsule attributes may comprise any or a combination of net weight of each filled capsule, gross weight of each filled capsules, weight of each capsules, first ingredient concentration in each filled capsule, second ingredient concentration in each filled capsule, operating speed of the capsule filling machine, feed rate of the empty capsules, ejection rate of the filled capsules, height of the slug in the slug formation unit, and weight of the slug being delivered by the slug formation unit to the filled capsule conveying unit

In an aspect, the system may comprise at least one third feeder fluidically coupled to the capsule filling machine and may be configured to supply a third ingredient to the capsule filling machine, and wherein the capsule filling machine may be configured to fill any or a combination of the mixture, the tertiary ingredients, the first ingredients, and the second ingredients in the plurality of empty capsules.

In an aspect, the system may comprise a containment to restrict exposure of any or a combination of the first ingredient, the second ingredient, and the mixture to operator and manufacturing facility.

### BRIEF DESCRIPTION OF THE DRAWINGS

The accompanying drawings are included to provide a further understanding of the present disclosure and are incorporated in and constitute a part of this specification. The drawings illustrate exemplary embodiments of the present disclosure and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary embodiment of a system for continuous production of filled capsules in accordance with the present disclosure.

FIGS. 2A and 2B illustrate another exemplary embodiment of the system for continuous production of filled capsules in accordance with the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

In the specification, reference may be made to the spatial relationships between various components and to the spatial orientation of various aspects of components as the devices are depicted in the attached drawings. However, as will be recognized by those skilled in the art after a complete reading of the present application, the devices, members, devices, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction.

The present disclosure relates to production/manufacturing of filled capsules. More particularly, the present disclosure relates to a production/manufacturing line for continuous production/manufacturing of filled capsules.

According to an aspect the present disclosure elaborates upon a system for continuous production of filled capsule, the system including: at least one continuous blender configured to receive and continuously blend a first ingredient and a second ingredient to form a mixture; and a capsule filling machine fluidically coupled with the at least one continuous blender, wherein the capsule filling machine can be adapted to fill a plurality of empty capsules with the mixture produced by the at least one continuous blender to provide a plurality of filled capsules.

In an embodiment, the system can include at least one first feeder fluidically coupled to a first inlet of the at least one continuous blender and can be configured to supply the first ingredient to the at least one continuous blender; and at least one second feeder fluidically coupled to a second inlet of the at least one continuous blender and can be configured to supply the second ingredient to the at least one continuous blender.

In an embodiment, the system can include one or more sensors positioned at predetermined positions in the system and can be configured to monitor one or more attributes of any or a combination of the first ingredient, the second ingredient, the mixture, the plurality of empty capsules, and the plurality of filled capsules.

In an embodiment, the system can include a control unit operatively coupled with the one or more sensors, the at least one continuous blender, the capsule filling machine, the at least one first feeder, and the at least one second feeder, and wherein the control unit can be adapted to transmit a set of control signals to any or a combination of the at least one continuous blender, the capsule filling machine, the at least one first feeder, and the at least one second feeder to configure the one or more attributes within a predefined range.

In an embodiment, the system can include a set of first sensors configured with the at least one first feeder to monitor one or more first ingredients attributes; and a set of second sensors configured with the at least one second feeder to monitor one or more second ingredients attributes, and wherein the one or more first ingredient attributes and the one or more second ingredient attributes can include any or a combination of blend uniformity, concentration, fingerprint, flowability, moisture content, weight, and particle size distribution.

In an embodiment, the system can include a first reservoir fluidically coupled to the at least one first feeder and can be adapted to store the first ingredient, and the system can include a second reservoir fluidically coupled to the at least one second feeder and can be adapted to store the second ingredient.

In an embodiment, the at least one first feeder and the at least one second feeder can include any or a combination of gravimetric feeder, and volumetric feeder to discharge a predefined quantity of the first ingredient and the second ingredient from the corresponding feeders.

In an embodiment, the system can include a first particle sizer adapted to allow the first ingredients having a first predefined size to flow from the at least one first feeder to the at least one continuous blender, and wherein the system can include a second particle sizer adapted to allow the second ingredients having a second predefined size to flow from the at least one second feeder to the at least one continuous blender.

In an embodiment, the system can include a set of third sensors configured with the first particle sizer to monitor one or more first ingredients attributes of the first ingredients discharged from the first particle sizer; and a set of fourth sensors configured with the second particle sizer to monitor one or more second ingredients attributes of the second ingredients discharged from the second particle sizer.

In an embodiment, the system can include a first valve operatively coupled to the at least one first feeder to control outflow of the first ingredients to the at least one first feeder, and wherein the system can include a second valve operatively coupled to the at least one second feeder to control outflow of the second ingredients to the at least one second feeder.

In an embodiment, the system can include a set of fifth sensors positioned at an outlet of the at least one continuous blender and can be configured to monitor one or more mixture attributes associated with the mixture discharged from the outlet, and wherein the one or more mixture attributes can include any or a combination of uniformity, concentration, fingerprint, flowability, moisture content, and particle size distribution.

In an embodiment, the system can include a diverter valve configured with the at least one continuous blender and can be adapted to divert the flow of the mixture having the one or more mixture attributes within a predefined range to the capsule filling machine.

In an embodiment, the diverter valve can be configured to divert the flow of the mixture failing to have the one or more mixture attributes within the predefined range to a rejection bin.

In an embodiment, the system can include a set of sixth sensors positioned at a location of the system to monitor location parameters including any or a combination of temperature, humidity, wind speed, and pressure.

In an embodiment, the system can include a capsule diagnosis unit fluidically coupled to the capsule filling machine, the capsule diagnosis unit can be configured to detect defects in the plurality of empty capsules and allow the plurality of empty capsules having a predetermined quality to pass to the capsule filling machine.

In an embodiment, the capsule filling machine can include a slug formation unit adapted to form a slug from the mixture discharged from the at least one continuous blender; a capsule orientation unit operatively coupled with the capsule diagnosis unit, the capsule orientation unit can be adapted to collect the plurality empty capsules released by the capsule diagnosis unit and orient the collected capsules in a predetermined orientation and release the empty oriented capsules; and a filled capsule conveying unit operatively coupled to the capsule orientation unit and can be configured to fill the slug the emptied oriented capsules.

In an embodiment, the system can include a set of seventh sensors configured with the capsule filling machine and can be adapted to monitor one or more capsule attributes of the plurality of capsules, and wherein the one or more capsule attributes can include any or a combination of net weight of each filled capsule, gross weight of each filled capsules, weight of each capsules, first ingredient concentration in each filled capsule, second ingredient concentration in each filled capsule, operating speed of the capsule filling machine, feed rate of the empty capsules, ejection rate of the filled capsules, height of the slug in the slug formation unit, and weight of the slug being delivered by the slug formation unit to the filled capsule conveying unit

In an embodiment, the system can include at least one third feeder fluidically coupled to the capsule filling machine and can be configured to supply a third ingredient to the capsule filling machine, and wherein the capsule filling machine can be configured to fill any or a combination of the mixture, the tertiary ingredients, the first ingredients, and the second ingredients in the plurality of empty capsules.

In an embodiment, the system can include a containment to restrict exposure of any or a combination of the first ingredient, the second ingredient, and the mixture to operator and manufacturing facility.

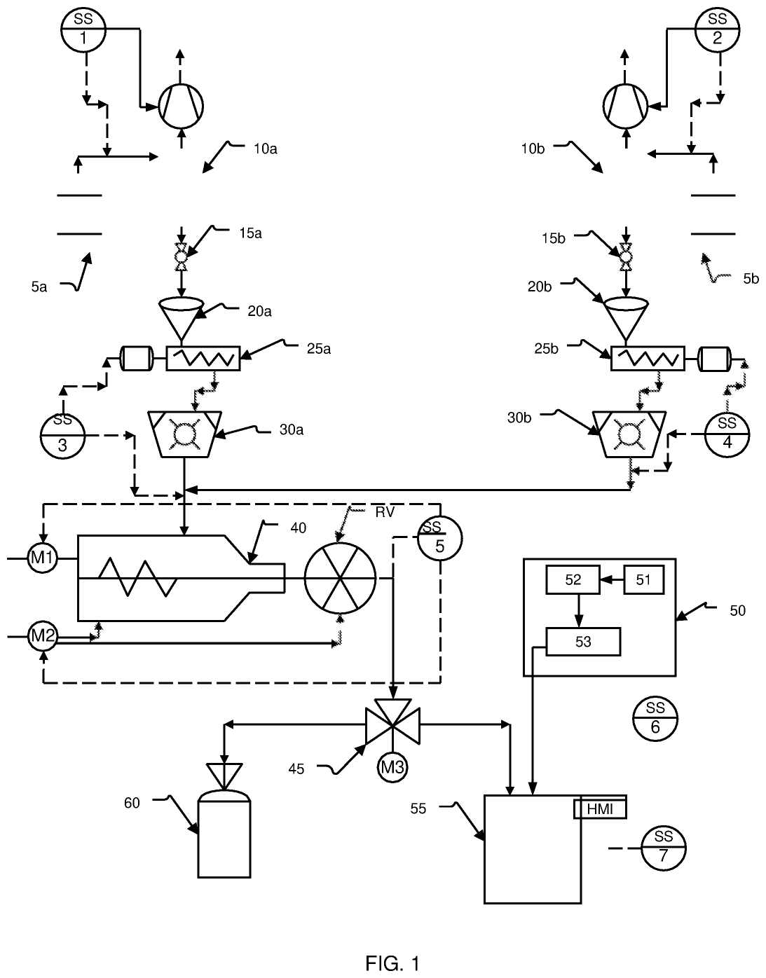

FIG. 1 illustrates an exemplary embodiment of a system for continuous production of filled capsules in accordance with the present disclosure.

As illustrated, in an aspect, the proposed system for continuous production of filled pharmaceutical and/or nutraceutical capsules can include at least one first feeder (20a, 25a) (also referred to as primary ingredient (API) feeder (20a, 25a), herein) where the API is a primary ingredient, at least one second feeder (20b, 25b) (also referred to as secondary ingredient feeder (20b, 25b), herein), at least one continuous blender (40) (also referred to as blender (40), herein) fluidically coupled with the primary ingredient feeder (20a, 25b) and the secondary ingredient feeder (20b, 25b), an empty capsule diagnosis unit (50), a capsule filling machine (55) fluidically coupled with the continuous blender (40) and the empty capsule diagnosis unit (50), a plurality of sensors (also referred to as sensors, herein), and a control unit.

In an exemplary embodiment, the primary ingredient can be active pharmaceutical ingredients (APIs), and nutraceutical ingredients. The secondary ingredients can be excipients and lubricants, but not limited to the likes. The APIs can be the active ingredients that can produce an intended pharmaceutical effect or medication. The excipients can be substances that can provide long-term stabilization to the active ingredients, bulking up solid formulations that contains the active ingredients, and confer therapeutic enhancement on the active ingredient.

The sensors can be deployed at pre-determined locations within the system to sense a plurality of attributes of the primary ingredient, the secondary ingredient, the mixture of the primary ingredient and the secondary ingredient, and empty and filled capsules, but not limited to the likes. In an exemplary embodiment, the attributes can include, but are not limited to, any or a combination of primary ingredient concentration, secondary ingredient concentration, particle size distribution, flowability of the mixture of the primary ingredient and the secondary ingredient, uniformity of the mixture of the primary ingredient and the secondary ingredient, assay, moisture content in the mixture of the primary ingredient and the secondary ingredient, and color of empty capsules.

In an embodiment, the sensors can be any or a combination of inductive sensor, capacitive sensor, spectral sensor (SS), laser sensor, and the like, including any or a combination of Near Infrared Spectroscopy, Raman Spectroscopy, Optical Coherence Topology, but not limited to the like.

In an embodiment, the control unit can be operatively coupled to the plurality of sensors. The control system, in response to at least one of the attributes being above or below a predefined threshold range, can be configured to control an actuating mechanism to manipulate at least one parameter in relation to any or a combination of the primary ingredient feeder (20a, 25a), the secondary ingredient feeder (20b, 25b), the continuous blender (40), the empty capsule diagnosis unit (50), and the capsule filling machine (55) to bring the at least one parameter within the predefined range to ensure that the filled capsules are of a predefined quality.

In an embodiment, the primary ingredient feeder (20a, 25a) can include a first hopper (20a), which at an inlet thereof can be fed with a primary ingredient or an Active Pharmaceutical Ingredient (API) by conventional or any other means available within a pharmaceutical factory. The primary ingredient can then be discharged to the continuous blender (40) through a first inlet of the continuous blender (40). In an exemplary embodiment, the primary ingredient feeder (20a, 25a) can include a primary ingredient gravimetric feeder, a primary ingredient volumetric, feeder, and the like, denoted by reference numeral (25a), fluidly connected to an outlet of the first hopper (20a) to measure the weight or the flowrate of the primary ingredient being discharged from the primary ingredient feeder (20a, 25a), whereby the discharge of the primary ingredient can be in metered quantities.

In an embodiment, the secondary ingredient feeder (20b, 25b) can also include a hopper (20b) which at an inlet thereof can be fed with a secondary ingredient by conventional or any other means available within a pharmaceutical factory. The secondary ingredient can then be discharged to the continuous blender (40) through a second inlet of the continuous blender (40). In an exemplary embodiment, the secondary ingredient feeder (20b, 25b) can include a secondary ingredient gravimetric feeder, a secondary ingredient volumetric, feeder, and the like, denoted by reference numeral (25b), fluidly connected to an outlet of the second hopper (25b) to measure the weight or the flowrate of the secondary ingredient being discharged from the secondary ingredient feeder, whereby the discharge of the secondary ingredient can be in metered quantities.

This technique of providing metered quantities of the primary ingredient and secondary ingredient from the primary ingredient feeder and the secondary ingredient feeder, respectively, is also generally referred to as “Gravimetric Loss-in-weight technique, Volumetric Loss-in-weight” technique, etc.

In an embodiment, the system can further include a first reservoir (5a) (also referred to as primary ingredient reservoir (5a), herein) for storing the primary ingredient. The system can include a primary ingredient conveying system (10a) fluidically coupled with the primary ingredient reservoir (5a) and a first valve (15a) provided downstream from the primary ingredient conveying system (10a). The primary ingredient can be transferred from the primary ingredient reservoir (5a) onto the primary ingredient conveying system (10a) and thereafter, via the first valve (15a), to the primary ingredient feeder (20a, 25a). The first valve (15a) can be configured to ensure that the primary ingredient from the primary ingredient conveying system (10a) passes therethrough to be fed into the first hopper (20a) of the primary ingredient feeder (20a, 25a) only when a predetermined refill limit of the primary ingredient feeder is reached.

In an embodiment, the system can further include a second reservoir (5b) (also referred to as secondary ingredient reservoir (5b), herein) for storing the secondary ingredient. The system can include a secondary ingredient conveying system (10b) fluidically coupled with the secondary ingredient reservoir (5b) and a second valve (15b) provided downstream from the secondary ingredient conveying system (10b). The secondary ingredient can be transferred from the secondary ingredient reservoir (5b) onto the secondary ingredient conveying system (10b) and thereafter, via the second valve (15b), to the secondary ingredient feeder (20b, 25b). The second valve (15b) can be configured to ensure that the secondary ingredient from the secondary ingredient conveying system (10b) passes therethrough to be fed into the second hopper (20b) of the secondary ingredient feeder (20b, 25b) only when a predetermined refill limit of the secondary ingredient feeder is reached.

In an embodiment, the system can include set of first sensors (also referred to as a first sensor (SS1), herein) to sense the attributes of the primary ingredient fed into or discharged from the primary ingredient feeder (20a, 25a). The first sensor (SS1) can be deployed at a location downstream from the primary ingredient reservoir (5a) or downstream from the primary ingredient feeder (20a, 25a). In accordance with the exemplary embodiment illustrated in FIG. 1, the first sensor (SS1) can be deployed in a fluid communication line downstream from the primary ingredient reservoir (5a), i.e. at a discharge side of the primary ingredient reservoir. The attributes sensed by the first sensor (SS1) can include, but are not limited to, any or a combination of primary ingredient uniformity, primary ingredient constituent concentration, primary ingredient fingerprint, moisture content, and primary ingredient particle size distribution.

In an embodiment, the system can include a set of second sensors (also referred to as second sensor (SS2), herein) is to sense the attributes of the secondary ingredient fed into or discharged from the secondary ingredient feeder (20b). The second sensor (SS2) can be deployed at a location downstream from the secondary ingredient reservoir (5b) or downstream from the secondary ingredient feeder (20b, 25b). In accordance with the exemplary embodiment illustrated in FIG. 1, the second sensor (SS2) can be deployed in a fluid communication line downstream from the secondary ingredient reservoir (5b), i.e. at a discharge side of the secondary ingredient reservoir. The attributes sensed by the second sensor (SS2) include, but are not limited to, any or a combination of secondary ingredient uniformity, secondary ingredient constituent concentration, secondary ingredient fingerprint, moisture content, and secondary ingredient particle size distribution.

In an embodiment, the system can include a first particle sizer (30a) (also referred to as primary ingredient particle sizer (30a), herein) fluidically coupled with the primary ingredient feeder (20a, 25a). Accordingly, the continuous blender (40) can be in fluid communication with the primary ingredient particle sizer (30a), whereby the primary ingredient discharged from the primary ingredient feeder (20a, 25a) can be transferred through the primary ingredient particle sizer (30a) to the continuous blender (40). The primary ingredient particle sizer (30a) can have one or more inlets, to facilitate one or more primary ingredients including the primary ingredient discharged from the primary ingredient feeder (20a, 25a), in either powder or granules form to be fed into the primary ingredient particle sizer through either of one or more inlets provided. The primary ingredient particle sizer (30a) typically includes an impeller (not particularly shown) and a sieve (not particularly shown). The primary ingredient fed through the inlet(s) can be agitated by the impeller, and thereafter forced through the sieve. This action ensures that primary ingredient particles/granules of a required size get filtered by the sieve and discharged at an outlet of the primary ingredient particle sizer (30a). The size of the primary ingredient particles/granules can be predefined by the holes in a mesh of the sieve.

In an embodiment, the system can include a set of third sensors (also referred to as third sensor (SS3), herein) to sense the attributes of the primary ingredient particles discharged from the primary ingredient particle sizer (30a). The third sensor (SS3) can be deployed at a location downstream from the primary ingredient particle sizer (30a). In accordance with the exemplary embodiment illustrated in FIG. 1, the third sensor (SS3) can be deployed in a fluid communication line downstream from the primary ingredient particle sizer (30a), i.e. at a discharge side of the primary ingredient particle sizer. The attributes sensed by the third sensor (SS3) can include any or a combination of primary ingredient particles uniformity, primary ingredient particles constituent concentration, primary ingredient particles fingerprint, and primary ingredient particles size distribution, but not limited to the likes.

In an embodiment, the system can include a second particle sizer (30b) (also referred to as a secondary ingredient particle sizer (30b), herein) fluidically coupled with the secondary ingredient feeder (20b, 25b). Accordingly, the continuous blender (40) can be in fluid communication with the secondary ingredient particle sizer (30b), whereby the secondary ingredient discharged from the secondary ingredient feeder (20b, 25b) can be transferred through the secondary ingredient particle sizer (30b) to the continuous blender (40). The secondary ingredient particle sizer (30a) can have one or more inlets, to facilitate one or more secondary ingredients including the secondary ingredient discharged from the secondary ingredient feeder (20b, 25b), in either powder or granules form to be fed into the secondary ingredient particle sizer through either of one or more inlets provided. The secondary ingredient particle sizer (30b) can include an impeller (not particularly shown) and a sieve (not particularly shown). The secondary ingredient fed through the inlet(s) can be agitated by the impeller, and thereafter forced through the sieve. This action ensures that secondary ingredient particles/granules of a required size are discharged at an outlet of the secondary ingredient particle sizer (30b). The size of the secondary ingredient particles/granules can be predefined by the holes in a mesh of the sieve.

In an embodiment, the system can include a set of fourth sensor (also referred to as fourth sensor (SS4), herein) to sense the attributes of the secondary ingredient particles discharged from the secondary ingredient particle sizer (30b). The fourth sensor (SS4) can be deployed at a location downstream from the secondary ingredient particle sizer (30b). In accordance with the exemplary embodiment illustrated in FIG. 1, the fourth sensor (SS4) can be deployed in a fluid communication line downstream from the secondary ingredient particle sizer (30b), i.e. at a discharge side of the secondary ingredient particle sizer. The attributes sensed by the fourth sensor (SS4) can include any or a combination of secondary ingredient particles uniformity, secondary ingredient particles constituent concentration, secondary ingredient particles fingerprint, and secondary ingredient particles” size distribution, but not limited to the likes.

In an embodiment, the continuous blender (40) can be in fluid communication with the primary ingredient feeder (20a, 25a) and the secondary ingredient feeder (20b, 25b) either directly or optionally through the primary ingredient particle sizer (30a) and the secondary ingredient particle sizer (30b) respectively. The continuous blender (40) can include one or more inlets whereby the primary ingredient particles from the primary ingredient feeder (20a, 25a) or the primary ingredient particle sizer (30a), and the secondary ingredient particles from the secondary ingredient feeder (20b, 25b) or the secondary ingredient particle sizer (30b) can be continuously fed in the continuous blender (40). The primary ingredient and secondary ingredient particles received in the continuous blender from the inlets can be continuously blended to form a mixture which can then discharged through an outlet of the continuous blender. In accordance with the exemplary embodiment illustrated in FIG. 1, the continuous blender (40) can include an impeller rotatable about a horizontal axis of rotation, and mounted with blades, the angle of orientation of which can be varied. The continuous blender of such type can also include at least two motors (M1, M2) to rotate the impeller about the horizontal axis of rotation and to vary the angle of orientation of the blades, respectively; and a rotary valve (RV) to adjust the size of a discharge outlet opening of the continuous blender.

In an embodiment, the continuous blender (40) can be a variable blade angle continuous blender adapted to vary the angle of orientation of one or more blades thereof even while the blender is in operation, i.e. when the impeller is rotating and the mixing is in progress. One example of such type of continuous blender is disclosed in Indian Patent Application no. 201821040352 which is incorporated herein by reference.

In an embodiment, the system can include a set of fifth sensors (also referred to as fifth sensor (SS5) to sense the attributes of the mixture discharged from the continuous blender (40). The fifth sensor (SS5) can be deployed at a location downstream from the continuous blender (40). In accordance with the exemplary embodiment illustrated in FIG. 1, the fifth sensor (SS5) can be deployed in a fluid communication line downstream from the continuous blender (40), i.e. at a discharge side of the continuous blender after the rotary valve (RV). The attributes sensed by the fifth sensor (SS5) can include, but are not limited to, any or a combination of uniformity of the mixture (percentage of primary ingredient, secondary ingredient, etc. in the mixture), flowability of the mixture, and moisture content in the mixture.

In an embodiment, the system can include a set of sixth sensor (also referred to as sixth sensor (SS6), herein) to sense the parameters of a room/location wherein the continuous manufacturing is carried out by the system. The sixth sensor (SS6) can be deployed at a suitable predetermined location in the room so as to be able to sense room parameters including, but not limited to, temperature, pressure, wind speed, and humidity.

In an embodiment, the system can include a capsule diagnosis unit (50) (also referred to as empty capsule diagnosis unit (50), herein) adapted to detect defects in the empty capsules being fed in the capsule filling machine (55), reject the empty capsules with defects and allow the empty capsules complying with a predetermined quality parameter to pass therethrough. The capsule diagnosis unit at an inlet thereof can be fed with different types of empty capsule of different sizes.

In an embodiment, the empty capsule diagnosis unit (50) can include an empty body/cap discarding unit (51), an empty capsule sorting unit (52) and an empty capsule inspection unit (53). The empty body/cap discarding unit (51) at an inlet thereof can be fed with different types of empty capsules of different sizes each with its body and cap closed. The empty body/cap discarding unit (51) can be adapted to detect any lose capsule body without any cap over it or any lose capsule cap that is not fitted over any capsule body and discard the lose capsule body and/or lose capsule cap. The empty capsule sorting unit (52) can coordinate with the empty body/cap discarding unit (51) to receive the closed empty capsules therefrom. The empty capsule sorting unit (52) can be adapted to inspect the empty capsules for various defects such as dents, impurities, etc. After inspection, the empty capsules free from these defects can be allowed to pass through, and defective empty capsules are rejected and discarded. The capsules can be inspected by means of camera inspection systems, mechanical length sorting, lose body sorting mechanism, and the like. The empty capsule inspection unit (53) can coordinate with the empty capsule sorting unit (52) to receive the empty capsules free from aforesaid defects and can be adapted to further inspect the empty capsules for compliance with quality/process physical parameters such as dimensions, geometric variation, color variation, but not limited to the likes. After inspection, the “quality complying” empty capsules can be allowed to pass through an outlet of the empty capsule inspection unit (53) downstream into a fluid communication line from the empty capsule diagnosis unit (50) towards the capsule filling machine (55), and defective empty capsules can be rejected and discarded.

In an embodiment, the capsule filling machine (55) can be fluidically coupled with the continuous blender (40) and also with the empty capsule diagnosis unit (50) to fill a plurality of empty capsules released by the empty capsule diagnosis unit with the mixture received from the continuous blender. The capsule filling machine can include a slug formation unit (not particularly shown), a capsule orientation unit (not particularly shown), and a filled capsule conveying unit (not particularly shown).

In an embodiment, the slug formation unit can be fluidically coupled with the continuous blender (40) and adapted to form a slug from the mixture of the primary ingredient and the secondary ingredient discharged from the continuous blender (40) and received therein. The slug formation unit can include a plurality of elongated slots wherein the received mixture is held. The slug can be formed by means of tamping technique where a plurality of tamping plungers penetrates the plurality of elongated slots wherein the mixture is held.

In an embodiment, the capsule orientation unit can be adapted to collect the empty (quality complying) capsules released by the empty capsule diagnosis unit (50) and can orient the collected capsules in a predetermined orientation and release the empty oriented capsules.

In an embodiment, the filled capsule conveying unit can cooperate with the capsule orientation unit and the slug formation unit. The filled capsule conveying unit can be adapted to perform the following sequence of operations: collect the empty oriented capsules released by the capsule orientation unit, separate a cap and a body of each empty capsule, collect the slug from the slug formation unit in the body of each empty capsule, close the cap over the body of the capsule with the slug filled therein, eject the filled capsules, and reject one or more filled capsules not meeting a predetermined attribute of filled capsules or not weighing within a desired range.

In an embodiment, the system can include a set of seventh sensors (also referred to as seventh sensor (SS7), herein to sense the attributes of the filled capsules ejected by the filled capsule conveying unit. The seventh sensor (SS7) can be deployed at a location downstream from the capsule filling machine (55). In accordance with the exemplary embodiment illustrated in FIG. 1, the seventh sensor (SS7) can be deployed at a discharge side of the filled capsule conveying unit. The attributes sensed by the seventh sensor (SS7) can include, but are not limited to, any or a combination of net weight of each filled capsule, primary ingredient concentration in each filled capsule, secondary ingredient concentration in filled capsule, operating speed of the capsule filling machine, feed rate of the empty capsules, ejection rate of the filled capsules, height of the slug in the slug formation unit, and weight of the slug being delivered from the slug formation unit to the filled capsule conveying unit.

In an embodiment, the control can be coupled with each of the of sensors SS1 to SS7. In response to one or more of the attributes sensed by the sensors being above or below a predefined threshold range, control system can take corrective action by transmitting a set of control signals to an actuating mechanism to manipulate at least one parameter in relation to any or a combination of the primary ingredient feeder (20a, 25a), the secondary ingredient feeder (20b, 25b), the continuous blender (40), the empty capsule diagnosis unit (50), and the capsule filling machine (55) to bring the one or more attributes within the predefined range to ensure that the filled capsules are of a predefined quality. The at least one parameter can include any or a combination of feed rate of the primary ingredient feeder (20a, 25a), feed rate of the secondary ingredient feeder (20b, 25b), speed of rotation (RPM) of an impeller of the primary ingredient gravimetric/volumetric feeder (25a), etc., speed of rotation (RPM) of an impeller of the secondary ingredient gravimetric/volumetric feeder (25b), etc., feed rate of the continuous blender (40), speed of rotation (RPM) of an impeller of the continuous blender (40), size of an exit opening of the continuous blender (40), the angle of orientation of one or more blades of the continuous blender while the continuous blender is in operation, feed rate of empty capsules, operating speed of the capsule filling machine (55), height of the slug in the slug formation unit, weight of the slug being delivered from the slug formation unit to the filled capsule conveying unit, height of penetration of a tamping plunger of the slug formation unit in a slug filled body of a capsule in the filled capsule conveying unit, ejection rate of filled capsules, and operation of the first valve, the second valve, and the rotary valve.

In an embodiment, the system can include a Human Machine Interface (HMI) operatively coupled to the control unit and configured to enable a user to provide the threshold ranges of the aforesaid attributes, and also monitor the aforesaid attributes in real-time. The user can send instructions to the control unit remotely using the HMI, which can send the set of control signals to the actuating mechanism to manipulate at least one parameter in relation to any or a combination of the primary ingredient feeder (20a, 25a), the secondary ingredient feeder (20b, 25b), the continuous blender (40), the empty capsule diagnosis unit (50), and the capsule filling machine (55) to bring the one or more attributes within the predefined range to ensure that the filled capsules are of a predefined quality, accordingly.

In an exemplary embodiment, the HMI can be any or a combination of a smart phone, tablet, and computer, but not limited to the likes.

The HMI can include a plurality of buttons to initiate a number of functions in the system to configure the at least one parameter. The user or operator can configure the system using the plurality of buttons of the HMI.

The HMI can include a display to provide graphical representation of the one or more attributes, sensor data, the at least one parameter associated with each of the components of the system, but not limited to the likes.

In an exemplary illustration, for example, in the event of receiving a signal from the fifth sensor (SS5) indicating that any of the attributes of the mixture of the primary ingredient and the secondary ingredient, are above or below a predefined threshold range, the control unit can take corrective action by controlling an actuating mechanism of the continuous blender (40) to manipulate at least one parameter in relation to the continuous blender. In accordance with the exemplary embodiment illustrated in FIG. 1, the control system can control the actuating mechanism comprising any one or both the motors (M1, M2) and/or the rotary valve (RV); wherein the motors (M1, M2) can be controlled to manipulate attributes such as a speed of rotation (RPM) of the impeller of the continuous blender and/or an angle of orientation of one or more blades of the continuous blender while the continuous blender is in operation, and the rotary valve (RV) can be controlled to adjust the size of a discharge outlet opening of the continuous blender.

In another example, in the event of receiving a signal from the sixth sensor (SS6) indicating that any of the room parameters are not within a predefined threshold range, the control unit can take corrective action by controlling an actuating mechanism of the empty capsule diagnosis unit (50) to manipulate the feed rate of empty capsules in the capsule filling machine (55) and/or notify an operator that the room parameters are not within the predefined threshold range and/or raise an alarm.

In yet another example, in the event of receiving a signal from the seventh sensor (SS7) indicating that the weight of the slug being delivered from the slug formation unit to the filled capsule conveying unit has deviated above or below a predefined threshold range, the control unit can take corrective action by controlling an actuating mechanism of the capsule filling machine (55) to reject the capsule filled with the deviated weight from the filled capsule conveying unit.

In an embodiment, the system can include a rejection bin (60) fluidically coupled with the continuous blender (40) through a diverter valve (45) provided downstream of the continuous blender. Accordingly, the slug formation unit of the capsule filling machine (55) can also be in fluid communication through the diverter valve (45) with the continuous blender (40). The diverter valve can be provided in a fluid communication line downstream from the continuous blender (40), such that an inlet of the diverter valve (45) is fluidly coupled to an outlet of the continuous blender (40), and one outlet of the diverter valve (45) is fluidly connected to an inlet of the rejection bin (60) and another outlet of the diverter valve (45) is fluidly connected to an inlet of the slug formation unit.

In an embodiment, the system can include a containment to restrict contain the mixture, the first ingredient, the second ingredient within a boundary to prevent exposure of working personnel around the system form the mixture, the first ingredient, the second ingredient. The module may be established in a room in a building, or in a container designed for the purpose. The system can be contained by being in a confined space, but the concept of “containment” includes designing the individual parts of the system to be “contained”, all in all making up a “system” in the sense of containment. By this design of the proposed system, all components of the system can be contained, thus reducing the risk of operator exposure and facilitating operation of the system, as all preparations of the system are carried out in a contained and controlled manner. The term “contained” within the context of the present application is defined by its level of containment according to suitable measurements, and is defined as at least dust-tight.

In another embodiment, the contained system can thus be seen as a single piece of equipment, allowing inlet of first ingredients and second ingredients at one end, and outlet of filled capsules at the other. Preferably, the single piece of system can include a physical confinement of the interfaces of the contained system. Such confinement can for instance be in the form of the specially designed valves, possibly supplemented with specially adapted tubing between the individual components of the system

In an exemplary implementation, at the start of the continuous manufacturing process in the continuous manufacturing line, a predesignated amount of time can be taken by the continuous blender (40) to perform mixing operation and achieve a steady state of mixing operation to release a mixture with the attributes thereof being within a predefined threshold range. Before the continuous blender (40) reaches the steady state, the quality of mixture initially discharged from the continuous blender can not be in conformity with the attributes being in the predefined threshold range, and therefore cannot be fed to the capsule filling machine. Hence, the initial mixture can be diverted via the diverter valve (45) to the rejection bin (60) and out of the continuous manufacturing line. Only after the steady state of mixing operation is reached, the mixture with the attributes within the predefined threshold range can be fed into the capsule filling machine (55). A third motor (M3) can be provided which can be controlled by the control unit to operate the diverter valve (45).

According to an aspect, a method for continuous production of filled capsules using the proposed system can include the steps of: receiving, in a primary ingredient feeder (20a, 25a), an active pharmaceutical ingredient; receiving, in a secondary ingredient feeder (20b, 25a), a secondary ingredient; receiving and continuously blending, in a continuous blender (40), the primary ingredient discharged from the primary ingredient feeder (20a, 25a) and the secondary ingredient discharged from the secondary ingredient feeder (20b, 25b), to form a mixture; filling, in a capsule filing machine (55), a plurality of empty capsules with the mixture.

In an embodiment, the method can further include a step of sensing, by one or more sensors, one or more attributes of any or a combination of the primary ingredient, the secondary ingredient, the mixture, and empty and filled capsules.

In an embodiment, the method can include a step of controlling, by a control unit in response to at least one of the attributes being above or below a predefined threshold range, an actuating mechanism to manipulate at least one parameter in relation to any or combination of the primary ingredient feeder, the secondary ingredient feeder, the continuous blender, and the capsule filling machine to bring the at least one of the attributes within the predefined range to ensure that the filled capsules are of a predefined quality.

In an embodiment, the method can include the steps of: transferring the primary ingredient from a primary ingredient reservoir (5a) to the primary ingredient feeder (20a, 25a) by a conveying system (10a); providing a first valve (15a) downstream from the conveying system (10a); and configuring the first valve (15a) to allow the primary ingredient to pass therethrough when a predetermined refill limit of the primary ingredient feeder (20a, 25a) is reached.

In another embodiment, the method can include the steps of: transferring the secondary ingredient from a secondary ingredient reservoir (5b) to the secondary ingredient feeder (20b, 25b) by a conveying system (10b); providing a second valve (15b) downstream from the conveying system (10b); and configuring the second valve (15b) to allow the secondary ingredient to pass therethrough when a predetermined refill limit of the secondary ingredient feeder (20b, 25a) is reached.

In an embodiment, the method can include the steps of: transferring the primary ingredient discharged from the primary ingredient feeder (20a, 25a) to a primary ingredient particle sizer (30a); agitating the primary ingredient in the primary ingredient particle sizer (30a); and filtering the agitated primary ingredient to allow primary ingredient particles of a predefined size to pass therethrough to the continuous blender (40).

In another embodiment, the method can include the steps of: transferring the secondary ingredient discharged from the secondary ingredient feeder (20b, 25a) to a secondary ingredient particle sizer (30b); agitating the secondary ingredient in the secondary ingredient particle sizer (30b); and filtering the agitated secondary ingredient to allow secondary ingredient particles of a predefined size to pass therethrough to the continuous blender (40).

In an embodiment, the method can include the steps of: detecting, by an empty capsule diagnosis unit (50), defects in the empty capsules; rejecting, by the empty capsule diagnosis unit (50), the empty capsules with defects; and allowing, by the empty capsule diagnosis unit (50) the empty capsules complying with a predetermined quality parameter to pass therethrough to the capsule filling machine (55).

According to another aspect a method for filling the empty capsules in the capsule filling machine (55) can include the steps of: forming a slug from the mixture of the primary ingredient and the secondary ingredient discharged from the continuous blender (40); collecting the empty capsules and orienting the collected empty capsules in a predetermined orientation and releasing the empty oriented capsules; collecting the empty oriented capsules, separating a cap and a body of each empty capsule, collecting the slug in the body of each empty capsule, closing the cap over the body of the capsule with the slug filled therein, ejecting the filled capsules; and rejecting one or more filled capsules not meeting a predetermined attribute of filled capsules.

In an embodiment, the method can further include the steps of: providing a diverter valve (45) downstream of the continuous blender (40); and diverting an initial mixture discharged from the continuous blender in a rejection bin (60) till at least one of the attributes of the mixture discharged from the continuous blender (40) is achieved, and upon achieving the at least one of the attributes of the mixture, diverting the mixture discharged from the continuous blender (40) in the capsule filling machine (55).

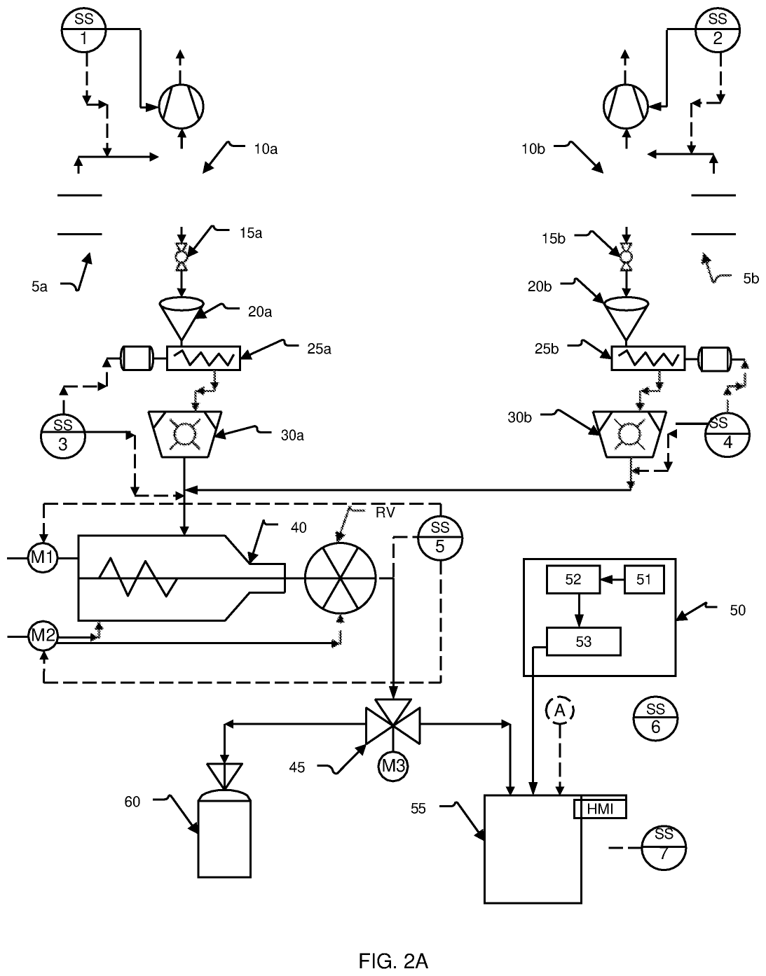

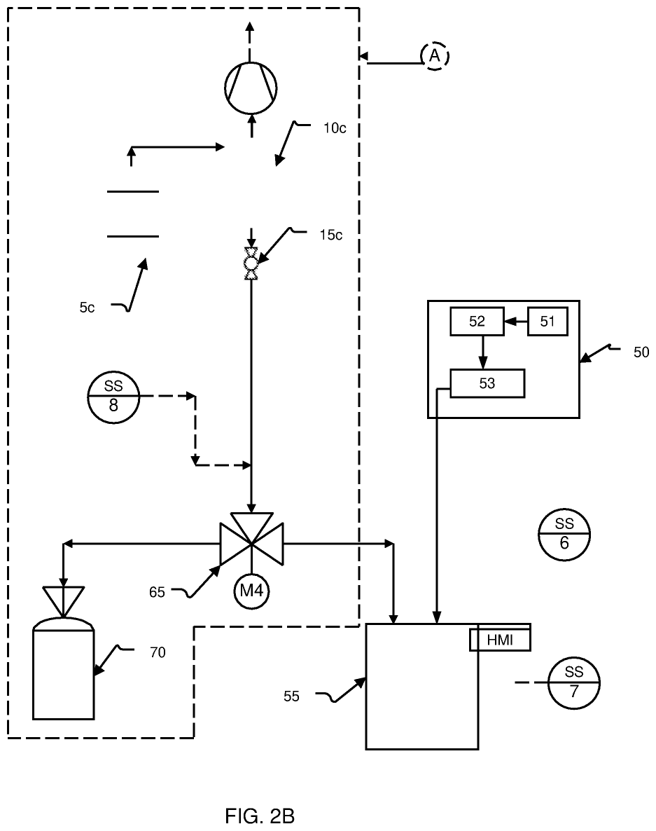

FIGS. 2A and 2B illustrate another exemplary embodiment of the system for continuous production of filled capsules in accordance with the present disclosure.

As illustrated, in an embodiment, the system can include an additional manufacturing line, denoted as “A” in FIGS. 2A and 2B, as a part of the aforesaid continuous manufacturing line for production of filled pharmaceutical and/or nutraceutical capsules. In accordance with an exemplary embodiment illustrated in FIG. 2B, the system can further include a tertiary ingredient reservoir (5c) for storing a tertiary ingredient such as granules, pellets, but not limited to the likes. The system can include a tertiary ingredient conveying system (10c) fluidically coupled with the tertiary ingredient reservoir (5c), a third valve (15c) provided downstream from the tertiary ingredient conveying system (10c), a tertiary ingredient diverter valve (65), a second rejection bin (70), and an eight sensor (SS8), but not limited to the likes.

In an embodiment, the tertiary ingredient diverter valve (65) can be provided in a fluid communication line downstream from the tertiary ingredient reservoir (5c), such that an inlet of the tertiary ingredient diverter valve (65) can be fluidly coupled to an outlet of the valve (15c), and one outlet of the tertiary ingredient diverter valve (65) can be fluidly coupled to an inlet of the second rejection bin (70) and another outlet of the tertiary ingredient diverter valve (65) can be fluidly coupled to the capsule filling machine (55). The tertiary ingredient, such as granules, pellets, and the like, can be transferred from the tertiary ingredient reservoir (5c) onto the tertiary ingredient conveying system (10c) and thereafter, via the valve (15c) and the tertiary ingredient diverter valve (65), to the capsule filling machine (55) or to the rejection bin (70). A fourth motor (M4) can be provided, which can be operated by the control system to operate the tertiary ingredient diverter valve (65).

In an embodiment, the system can include a set of eighth sensors (also referred to as eighth sensor (SS8), herein) to sense the attributes of the tertiary ingredient discharged from the tertiary ingredient reservoir (5c). Accordingly, the eighth sensor (SS8) can be deployed at a location downstream from the tertiary ingredient reservoir (5c). In accordance with the exemplary embodiment illustrated in FIG. 2, the eighth sensor (SS8) can be deployed in a fluid communication line downstream from the valve (15c), i.e. at a discharge side of the third valve (15c). The attributes sensed by the eight sensor (SS8) can include, but are not limited to, any or a combination of tertiary ingredient uniformity, tertiary ingredient constituent concentration, tertiary ingredient fingerprint, tertiary ingredient particle size distribution, and moisture content in the tertiary ingredient.

In an embodiment, the eighth sensor (SS8) can be operatively coupled to the control unit. In response to the attributes of the tertiary ingredient sensed by the eighth sensor being above or below a predefined threshold range, the control unit can take corrective action by controlling an actuating mechanism to manipulate at least one parameter in relation to said additional manufacturing line to bring the attributes within the predefined range to ensure that the filled capsules are of a predefined quality.

In an implementation, for example, in the event of receiving a signal from the eighth sensor (SS8) indicating that any of the attributes of the tertiary ingredient is above or below a predefined threshold range, the control system can take corrective action by controlling an actuating mechanism of the tertiary ingredient diverter valve (65). In accordance with the exemplary embodiment illustrated in FIG. 2, the control unit can control the fourth motor (M4) of the tertiary ingredient diverter valve (65) to close the outlet thereof, which is fluidly connected to the inlet of the slug formation unit of the capsule filling machine (55) and to open the outlet thereof which is fluidly connected to the inlet of the second rejection bin (70) to divert the tertiary ingredient to the rejection bin (70).

According to an embodiment, the method for continuous production of filled capsules using the proposed system can include the steps of: receiving, in a capsule filling machine (55), an active pharmaceutical; the mixture blended by the continuous blender (55) and a tertiary ingredient; and filling, in the capsule filling machine (55), a plurality of empty capsules with the mixture and the tertiary ingredient.

In an embodiment, the method can include a step of sensing, by the one or more sensors, a plurality of attributes of any or a combination of the primary ingredient, the secondary ingredient, the mixture, the tertiary ingredient, and empty and filled capsules.

In an embodiment, the method can include a step of controlling, by the control unit in response to at least one of the attributes being above or below a predefined threshold range, an actuating mechanism to manipulate at least one parameter in relation to any or combination of the primary ingredient feeder, the secondary ingredient feeder, the continuous blender, and the capsule filling machine to bring the at least one of attributes within the predefined range to ensure that the filled capsules are of a predefined quality.

In an embodiment, the method can include the steps of: transferring the tertiary ingredient from a tertiary ingredient reservoir (5c) to the capsule filling machine; diverting, by a tertiary ingredient diverter valve (65), the tertiary ingredient discharged from the tertiary ingredient reservoir (5c) in a rejection bin (70) till at least one of the attributes of the tertiary ingredient is achieved; and diverting, by a tertiary ingredient diverter valve (65), the tertiary ingredient discharged from the tertiary ingredient reservoir (5c) in the capsule filling machine (55) upon achieving the at least one of the attributes of the tertiary ingredient.

In the systems for continuous production of filled capsules as described in the aforesaid exemplary embodiments, the various components viz, the reservoirs, feeders, continuous blender and the capsule filling machine could also serve to “contain” the ingredients therein so as to prevent an operator from coming in direct contact with the ingredients. Once the ingredients are loaded in the reservoirs and/or feeders, the operator will not have direct access/exposure to any ingredient in any component while the manufacturing is in process. Such “containment” of the ingredients in the components is necessary to prevent the operator from coming in direct contact with any potent ingredient to avoid harmful effects thereof on the operator. Exposure data may be evaluated for instance by a SMEPAC (Standardized Measurement of Equipment Particulate Airborne Concentration) test. SMEPAC has been adopted into the ISPE-Guide “Assessing the Particulate Containment Performance of Pharmaceutical Equipment” (ISBN: 1-931879-35-4). In practice, a desired level of containment is chosen among such levels as contained or dust-tight (10-100 mcg/m³), high contained (1-10 mcg/m³) and total contained (<1 mcg/m³), and suitable equipment is chosen in accordance with the desired containment levels. The term “contained” within the context of the present disclosure is defined by its level of containment according to the SMEPAC test, or any corresponding, suitable measurement, and is thus defined as at least dust-tight according to the above-identified standard.

It can be readily appreciated that the systems for continuous production of filled capsules and the methods therefor as disclosed herein above provides various advantages including, but not limited to, built-in quality control system, a continuous blender capable of varying the blades thereof even while the blender is in operation, measurement of various parameters related to the ingredients used for manufacturing the capsules, as well as, the filled and empty capsules, for ensuring that the filled capsules are of a predefined quality, eliminating the risk of human error in manufacturing of filled capsules by reducing human intervention during manufacturing.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### Advantages of the Invention

The present disclosure provides a continuous pharmaceutical and/or nutraceutical processing system for production of filled capsules.

The present disclosure provides a continuous pharmaceutical and/or nutraceutical processing system for production of filled capsules with built-in quality control system.

The present disclosure provides a continuous pharmaceutical and/or nutraceutical processing system wherein various parameters related to the materials/ingredients used for manufacturing the capsules, as well as, the filled and empty capsules, are measured for ensuring the quality of the filled capsules.

The present disclosure eliminates the risk of human error in continuous manufacturing of filled capsules by reducing human intervention during manufacturing.

1. A system for continuous production of filled capsule, the system comprising:
at least one continuous blender configured to receive and continuously blend a first ingredient and a second ingredient to form a mixture; and
a capsule filling machine fluidically coupled with the at least one continuous blender, wherein the capsule filling machine is adapted to fill a plurality of empty capsules with the mixture produced by the at least one continuous blender to provide a plurality of filled capsules.

2. The system as claimed in claim 1, wherein the system comprises:
at least one first feeder fluidically coupled to a first inlet of the at least one continuous blender and configured to supply the first ingredient to the at least one continuous blender; and
at least one second feeder fluidically coupled to a second inlet of the at least one continuous blender and configured to supply the second ingredient to the at least one continuous blender.

3. The system as claimed in claim 2, wherein the system comprises one or more sensors positioned at predetermined positions in the system and configured to monitor one or more attributes of any or a combination of the first ingredient, the second ingredient, the mixture, the plurality of empty capsules, and the plurality of filled capsules.

4. The system as claimed in claim 3, wherein the system comprises a control unit operatively coupled with the one or more sensors, the at least one continuous blender, the capsule filling machine, the at least one first feeder, and the at least one second feeder, and wherein the control unit is adapted to transmit a set of control signals to any or a combination of the at least one continuous blender, the capsule filling machine, the at least one first feeder, and the at least one second feeder to configure the one or more attributes within a predefined range.

5. The system as claimed in claim 2, wherein the system comprises a set of first sensors configured with the at least one first feeder to monitor one or more first ingredients attributes; and a set of second sensors configured with the at least one second feeder to monitor one or more second ingredients attributes, and wherein the one or more first ingredient attributes and the one or more second ingredient attributes comprise any or a combination of blend uniformity, concentration, fingerprint, flowability, moisture content, weight, and particle size distribution.

6. The system as claimed in claim 2, wherein the system comprises a first reservoir fluidically coupled to the at least one first feeder and adapted to store the first ingredient, and the system comprises a second reservoir b fluidically coupled to the at least one second feeder and adapted to store the second ingredient.

7. The system as claimed in claim 2, wherein the at least one first feeder and the at least one second feeder comprise any or a combination of gravimetric feeder, and volumetric feeder to discharge a predefined quantity of the first ingredient and the second ingredient from the corresponding feeders.

8. The system as claimed in claim 2, wherein the system comprises a first particle sizer adapted to allow the first ingredients having a first predefined size to flow from the at least one first feeder to the at least one continuous blender, and wherein the system comprises a second particle sizer adapted to allow the second ingredients having a second predefined size to flow from the at least one second feeder to the at least one continuous blender.

9. The system as claimed in claim 8, wherein the system comprises a set of third sensors configured with the first particle sizer to monitor one or more first ingredients attributes of the first ingredients discharged from the first particle sizer; and a set of fourth sensors configured with the second particle sizer to monitor one or more second ingredients attributes of the second ingredients discharged from the second particle sizer.

10. The system as claimed in claim 2, wherein the system comprises a first valve operatively coupled to the at least one first feeder to control outflow of the first ingredients to the at least one first feeder, and wherein the system comprises a second valve operatively coupled to the at least one second feeder to control outflow of the second ingredients to the at least one second feeder.

11. The system as claimed in claim 1, wherein the system comprises a set of fifth sensors positioned at an outlet of the at least one continuous blender and configured to monitor one or more mixture attributes associated with the mixture discharged from the outlet, and wherein the one or more mixture attributes comprises any or a combination of uniformity, concentration, fingerprint, flowability, moisture content, and particle size distribution.

12. The system as claimed in claim 11, wherein the system comprises a diverter valve configured with the at least one continuous blender and adapted to divert the flow of the mixture having the one or more mixture attributes within a predefined range to the capsule filling machine.

13. The system as claimed in claim 12, wherein the diverter valve is configured to divert the flow of the mixture failing to have the one or more mixture attributes within the predefined range to a rejection bin.

14. The system as claimed in claim 1, wherein the system comprises a set of sixth sensors positioned at a location of the system to monitor location parameters comprising any or a combination of temperature, humidity, wind speed, and pressure.

15. The system as claimed in claim 1, wherein the system comprises a capsule diagnosis unit fluidically coupled to the capsule filling machine, the capsule diagnosis unit configured to detect defects in the plurality of empty capsules and allow the plurality of empty capsules having a predetermined quality to pass to the capsule filling machine.

16. The system as claimed in claim 15, wherein the system comprises a set of seventh sensors configured with the capsule filling machine and adapted to monitor one or more capsule attributes of the plurality of capsules, and wherein the one or more capsule attributes comprises any or a combination of net weight of each filled capsule, gross weight of each filled capsules, weight of each capsules, first ingredient concentration in each filled capsule, second ingredient concentration in each filled capsule, operating speed of the capsule filling machine, feed rate of the empty capsules, ejection rate of the filled capsules, height of the slug in the slug formation unit, and weight of the slug being delivered by the slug formation unit to the filled capsule conveying unit.

17. The system as claimed in claim 1, wherein the system comprises at least one third feeder fluidically coupled to the capsule filling machine and configured to supply a third ingredient to the capsule filling machine, and wherein the capsule filling machine is configured to fill any or a combination of the mixture, the tertiary ingredients, the first ingredients, and the second ingredients in the plurality of empty capsules.

18. The system as claimed in claim 15, wherein the system comprises a containment to restrict exposure of any or a combination of the mixture, the first ingredients, and the second ingredients to operator and manufacturing facility.
